(19) United States
(12) Patent Application Publication
(10) Pub. No.: US 2015/0076203 A1
(43) Pub. Date: Mar. 19, 2015

(54) GLASS SHEET CUTTING APPARATUS, GLASS SHEET CUTTING METHOD, GLASS SHEET MANUFACTURING METHOD, AND GLASS SHEET CUTTING SYSTEM

(71) Applicant: NIPPON ELECTRIC GLASS CO., LTD., Shiga (JP)

(72) Inventors: Kenji Mishina, Shiga (JP); Takashi Hashimoto, Shiga (JP); Koji Ichikawa, Shiga (JP)

(73) Assignee: NIPPON ELECTRIC GLASS CO., LTD., Shiga (JP)

(21) Appl. No.: 14/357,656

(22) PCT Filed: Nov. 9, 2012
(86) PCT No.: PCT/JP2012/079155

§ 371 Date: May 12, 2014

(30) Foreign Application Priority Data
Nov. 16, 2011 (JP) 2011-251036

(51) Int. Cl. C03B 33/033

(52) U.S. Cl. CPC C03B 33/033
USPC 225/96

(57) ABSTRACT

A glass sheet cutting apparatus (100) according to the present invention includes a cleaving member (10) configured to apply a force to, of a glass sheet (G) having a main surface (Ga) and a main surface (Gb) in which a scribe line (S) is formed, the main surface (Ga), and a pressing member (20) configured to press the main surface (Gb) of the glass sheet (G). The pressing member (20) has a brush-like shape. Preferably, the pressing member (20) has a rectangular shape along the scribe line (S) as viewed in a normal direction of the main surface (Gb).

### TECHNICAL FIELD

The present invention relates to glass sheet cutting apparatuses, glass sheet cutting methods, glass sheet manufacturing methods, and glass sheet cutting systems.

### BACKGROUND ART

Glass sheets are suitably used in flat panel displays, such as liquid crystal panels, plasma display panels, etc. Such a glass sheet is manufactured by cutting a comparatively large glass sheet (it may be called “mother glass” also) into predetermined size. In particular, in order to cut a comparatively thin glass sheet, the glass sheet is cut typically in a manner that after a scribe line (division line) is formed in one of the main surfaces of the glass sheet, a force is applied to the other main surface thereof with the use of a cleaving member in a state in which the main surface in which the scribe line is formed is pressed (see Patent Literature 1, for example).

Patent Literature 1 discloses a cleaving apparatus (cutting apparatus) that applies a force to the lower main surface of the thin glass sheet with the use of a cleaving bar in a state in which a pressing bar is brought down on the upper main surface of the thin glass sheet, in which the scribe line is formed, and presses the glass sheet. Further, Patent Literature 1 states that a rubber sheet is attached to the lower surface of the pressing bar.

### CITATION LIST

### Patent Literature

[Patent Literature 1] Japanese Patent Application Laid-Open Publication No. 2007-099563

### SUMMARY OF INVENTION

### Technical Problem

Typically, the cutting apparatus repeats cutting of glass sheet. However, glass powder, which may be generated in cutting the glass sheet, may adhere to the pressing bar or the rubber sheet in the cleaving device according to Patent Literature 1. When the pressing bar or the rubber sheet is pressed against another glass sheet to be cut thereafter, a flaw may be made on the surface of the glass sheet.

Further, in the case when a large glass sheet as described above is to cut, the single large glass sheet may be cut twice in different directions to obtain a plurality of comparatively small glass sheets. However, the cleaving device in Patent Literature 1 cannot perform efficient cutting of the glass sheet in the different directions.

The present invention has been made in view of the foregoing problems and has its object to provide a glass sheet cutting apparatus, a glass sheet cutting method, a glass sheet manufacturing method, and a glass sheet cutting system, in which flaws on a glass sheet made by glass powder in cutting the glass sheet can be reduced. Further, another object of the present invention is to provide a glass sheet cutting system capable of performing efficient cutting of a glass sheet in different directions.

### Solution to Problem

A glass sheet cutting apparatus according to the present invention is a glass sheet cutting apparatus including: a cleaving member configured to apply a force to, of a glass sheet having a first main surface and a second main surface in which a scribe line is formed, the first main surface; and a pressing member configured to press the second main surface of the glass sheet. The pressing member has a brush-like shape.

In one embodiment, the pressing member has a rectangular shape along the scribe line as viewed in a normal direction of the second main surface.

In one embodiment, the pressing member presses the glass sheet in a vertical direction.

In one embodiment, the pressing member includes a plurality of bristles. Each of the bristles has a diameter of 0.05 mm or larger and 0.30 mm or smaller.

In one embodiment, each of the bristles has a length of 5.0 mm or longer and 20.0 mm or shorter.

A glass sheet cutting system according to the present invention includes a plurality of the above glass sheet cutting apparatus.

In one embodiment, scribe lines extending in a first direction or a second direction intersecting with each other are formed in the glass sheet. The plurality of glass sheet cutting apparatuses include: a first glass sheet cutting apparatus configured to cut the glass sheet conveyed in a conveyance direction along the scribe line extending in the first direction; and a second glass sheet cutting apparatus configured to cut, after the glass sheet cut by the first glass sheet cutting apparatus is conveyed in the conveyance direction, the glass sheet along the scribe line extending in the second direction.

A glass sheet cutting method according to the present invention is a glass sheet cutting method which includes: pressing, of a glass sheet having a first main surface and a second main surface in which scribe line is formed, the second main surface; and cleaving the glass sheet by applying a force to the first main surface of the glass sheet. The second main surface of the glass sheet is pressed by a brush-like pressing member in the pressing.

A glass sheet manufacturing method according to the present invention is a glass sheet manufacturing method for manufacturing a glass sheet by cutting a mother glass, which includes: preparing mother glass having a first main surface and a second main surface in which a scribe line is formed; pressing the second main surface of the mother glass; and taking out a glass sheet manufactured by cutting the mother glass by applying a force to the first main surface of the mother glass. The second main surface of the glass sheet is pressed by a brush-like pressing member in the pressing.

A glass sheet cutting system according to the present invention is a glass sheet cutting system to cut a glass sheet in which a scribe line extending in a first direction and a scribe line extending in a second direction intersecting with the first direction are formed. The glass sheet cutting system includes: a first glass sheet cutting apparatus configured to cut the glass sheet conveyed in a conveyance direction along the scribe line extending in the first direction; and a second glass sheet cutting apparatus configured to cut, after the glass sheet cut by the first glass sheet cutting apparatus is conveyed in the conveyance direction, the glass sheet along the scribe line extending in the second direction.

In one embodiment, a plurality of scribe lines extending in a direction orthogonal to the conveyance direction as the first direction or the second direction are formed in the glass sheet before being conveyed to the first glass sheet cutting apparatus. One of the first glass sheet cutting apparatus and the second glass sheet cutting apparatus cuts the glass sheet along some scribe line out of the plurality of scribe lines. The glass sheet cutting system further includes a third glass sheet cutting apparatus configured to cut, after the glass sheet cut by the one glass sheet cutting apparatus is conveyed in the conveyance direction, the glass sheet along a scribe line, along which the one glass sheet cutting apparatus does not cut the glass sheet, out of the plurality of scribe lines.

In one embodiment, the first glass sheet cutting apparatus cuts the glass sheet in a direction parallel to the conveyance direction. The second glass sheet cutting apparatus cuts the glass sheet in a direction orthogonal to the conveyance direction.

In one embodiment, two or more scribe lines extending in the first direction are formed in the glass sheet before the first glass sheet cutting apparatus cuts the glass sheet. The first glass sheet cutting apparatus cuts the glass sheet along the plurality of scribe lines extending in the first direction at one time.

In one embodiment, the glass sheet cutting system further includes a conveyor configured to scrap, after at least one of the first glass sheet cutting apparatus and the second glass sheet cutting apparatus cuts the glass sheet along the scribe line(s), a glass sheet located on at least one of opposite end sides of the cut glass sheet.

In one embodiment, the glass sheet cutting system further includes a scribe line forming apparatus configured to form, before the first glass sheet cutting apparatus cuts the glass sheet, a scribe line extending in the first direction and a scribe line extending in the second direction in the glass sheet.

### Advantageous Effects of Invention

According to the present invention, flaws on a glass sheet, which may be made by glass powder in cutting a glass sheet, can be reduced. Further, according to the present invention, glass sheet can be cut efficiently in different directions.

### BRIEF DESCRIPTION OF DRAWINGS

FIG. 1 is a schematic illustration showing one embodiment of a glass sheet cutting apparatus according to the present invention.

FIGS. 2A-2C are schematic illustrations for explaining a glass sheet cutting method according to the present invention.

FIG. 3 is a schematic illustration showing a glass sheet cutting apparatus according to the present embodiment.

FIG. 4 is a schematic illustration showing a glass sheet cutting apparatus according to the present embodiment.

FIG. 5 is a schematic illustration showing a glass sheet cutting apparatus according to the present embodiment.

FIG. 6 is a schematic illustration showing one embodiment of a glass sheet cutting system according to the present invention.

FIG. 7 is a schematic illustration showing a glass sheet cutting system according to the present embodiment.

FIG. 8 is a schematic illustration showing a glass sheet cutting system according to the present embodiment.

FIG. 9 is a schematic illustration showing the vicinity of a part of a first glass sheet cutting apparatus in the glass sheet cutting system shown in FIG. 8.

FIG. 10 is a schematic illustration showing the vicinity of a part of a second glass sheet cutting apparatus in the glass sheet cutting system shown in FIG. 8.

FIG. 11 is a schematic illustration showing a glass sheet cutting system according to the present embodiment.

### DESCRIPTION OF EMBODIMENTS

With reference to the accompanying drawings, embodiments will be described below about a glass sheet cutting apparatus, a glass sheet cutting method, a glass sheet manufacturing method, and a glass sheet cutting system according to the present invention. However, the present invention is not limited to the following embodiments.

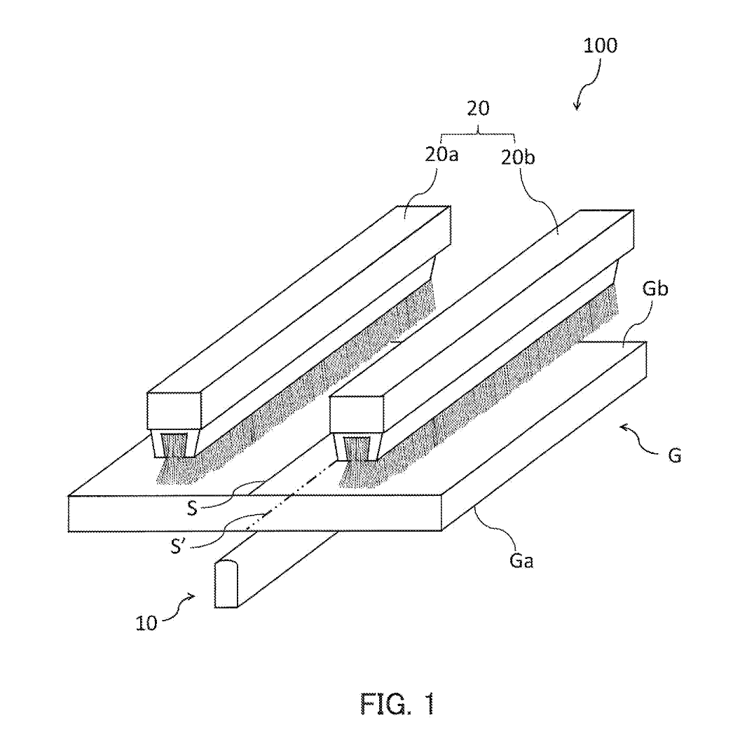

FIG. 1 is a schematic illustration showing one embodiment of a glass sheet cutting apparatus according to the present invention. A glass sheet cutting apparatus 100 includes a cleaving member 10 and a pressing member 20. The glass sheet cutting apparatus 100 cuts a glass sheet G having main surfaces Ga and Gb. A substantially linearly extending grove is formed as a scribe line S in the main surface Gb of the glass sheet G. Typically, when viewing a cross section orthogonal to the direction in which the scribe line S extends, the scribe line S is in a V-shape or a U-shape. The scribe line S may include a median crack extending from the groove. Further, in FIG. 1, a line S′ corresponding (opposite) to the scribe line S is indicated by a broken line in the main surface Ga of the glass sheet G. It is noted that the scribe line S is formed in a grooved shape, while the line S′ is not formed into a groove. In the present specification, the main surface Ga may be referred to as a first main surface Ga, while the main surface Gb may be referred to as a second main surface Gb.

The cleaving member 10 applies a force to the first main surface Ga of the glass sheet G. Typically, the cleaving member 10 applies the force along the line S′ or to the vicinity thereof in the first main surface Ga of the glass sheet G. When the cleaving member 10 applies the force to the main surface Ga of the glass sheet G, bending stress is generated around the scribe line S.

Further, the pressing member 10 applies a force to the second main surface Gb of the glass sheet G. Typically, the pressing member 20 applies the force to the both sides of and parallel to the scribe line S in the second main surface Gb of the glass sheet G. The cleaving member 10 applies the force to the first main surface Ga of the glass sheet G after the pressing member 20 applies the force to the second main surface Gb of the glass sheet G, thereby generating bending stress around the scribe line S to cut the glass sheet G.

The pressing member 20 is in a brush-like shape in the glass sheet cutting apparatus 100 according to the present embodiment. The brush-like shape of the pressing member 20 can reduce flaws, which may be made on the glass sheet G by glass powder in pressing by the pressing member 20.

Further, even if the glass powder may adhere to or bite into the pressing member 20, the surface of the glass sheet G can be prevented from being flawed because elastic bristles of the brush can bent upon contact with the glass sheet G. Moreover, the elastic brush can absorb shock at cleaving, thereby reducing breakage of the glass sheet G. Still more, the brush-like pressing member 20 even in pressing the glass sheet G can allow the bristle ends of the brush to follow minute movement of the glass sheet in the transverse direction and/or the vertical direction, which is caused at cleaving. Accordingly, the glass sheet G can be cut without applying an excessive force to the glass sheet G even if the position where the glass sheet G is to be pressed is not precisely adjusted. Thus, the glass sheet G can be cut in the depth direction of the scribe line S (direction vertical to the main surfaces Ga and Gb of the glass sheet G) without need of forcible pulling of the glass sheet G in cutting, thereby obtaining a cleaved facet substantially orthogonal to the main surfaces Ga and Gb of the glass sheet G.

Here, two channel brushes 20a and 20b are used as the pressing member 20. The channel brushes 20a and 20b each have a rectangular shape along the scribe line S when viewed in the normal direction of the second main surface Gb of the glass sheet G. The channel brushes 20a and 20b have a length in the longitudinal direction longer than the length of the scribe line S of the glass sheet G.

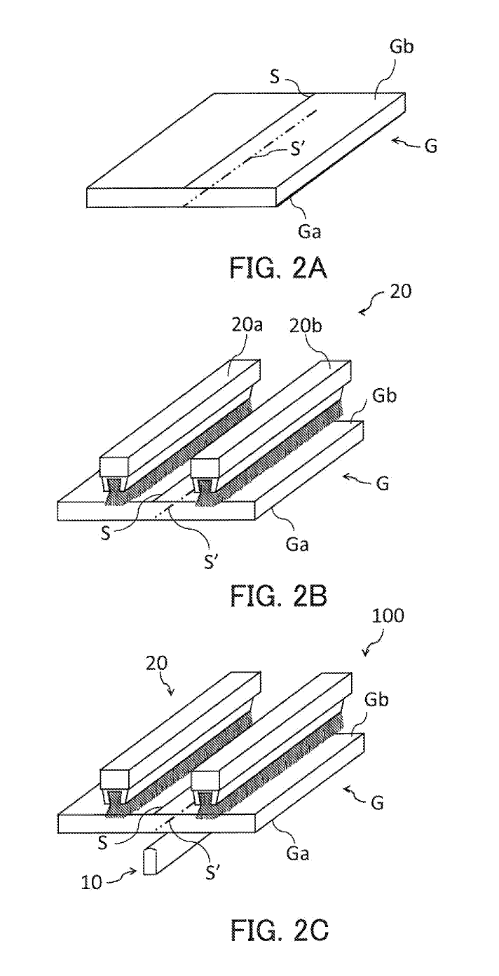

Referring to FIG. 2, a glass sheet cutting method according to the present embodiment will be described herein. First, as shown in FIG. 2A, a glass sheet G is prepared. The glass sheet G has a first main surface Ga and a second main surface Gb. A scribe line S is formed in the second main surface Gb.

Next, as shown in FIG. 2B, the pressing member 20 applies a force to the second main surface Gb. At this time, the pressing member 20 preferably presses the glass sheet G in the vertical direction. The pressing member 20 herein is brought down toward the glass sheet G in the vertical direction. It is noted that the brushes 20a and 20b may press the glass sheet G at parts spaced equal or different distances apart from the scribe line S.

Next, as shown in FIG. 2C, a cleaving member 10 applies a force to the first main surface Ga of the glass sheet G while the pressing member 20 applies the force to the glass sheet G. The cleaving member 10 herein is brought up toward the glass sheet G in the vertical direction. This generates bending stress around the scribe line S of the glass sheet G, thereby cutting the glass sheet G. In the present embodiment, the glass sheet G is used as mother glass. Cutting the mother glass G can result in obtainment of glass sheets smaller than the mother glass G from the mother glass G.

As described above, the cleaving member 10 applies the force to the glass sheet G being pressed by the pressing member 20. However, little difference may be made between the time when the cleaving member 10 comes in contact with the glass sheet G and the time when the pressing member 20 comes in contact with the glass sheet G.

The pressing member 20 in the glass sheet cutting apparatus 100 of the present embodiment includes a plurality of bristles. For example, channel brushes in which resin fibers are serially implanted may be suitably used as the pressing member 20. The resin fibers may be chemical fibers made from, for example, nylon 66, nylon 6, nylon 610, nylon 612, polypropylene, vinyl chloride, polyester, fluorofiber, etc. In view of flaw prevention, nylon 66 is preferable among of them.

Further, the diameter of the resin fibers is preferably 0.05 mm or larger and 0.30 mm or smaller. In this case, even if the force of the pressing member 20 to press the glass sheet G is controlled not so precisely, the glass sheet G can be less flawed and can be pressed reliably. It is noted that where the diameter of the resin fibers is equal to or larger than 0.5 mm, too strong force of the pressing member 20 to the glass sheet G may make a flaw on the glass sheet G. By contrast, where the diameter of the resin fibers is smaller than 0.05 mm, insufficient force may be applied to the glass sheet G in cutting.

Moreover, the length of the resin fibers is preferably 5.0 mm or longer and 20.0 mm or shorter. In this case, even if the force of the pressing member 20 to press the glass sheet G is controlled not so precisely, the bristles can follow minute movement of the glass sheet G, which is caused in cutting, and can press the glass sheet G reliably. It is noted that where the length of the resin fibers is shorter than 5.0 mm, inappropriate control on the pressing force may lead to insufficient following of the bristles to the minute movement caused in cutting. By contrast, where the length of the resin fiber is longer than 2.00 mm, insufficient force may be applied to the glass sheet G in cutting.

It is noted that the present invention is not limited to the above description with reference to FIGS. 1 and 2, in which the channel brush 20a presses one of two regions defined by the scribe line S in the glass sheet G, while the other channel brush 20b presses the other region. A brush-like member may press one of the two regions defined by the scribe line S in the glass sheet G, while another member may press the other region. In this manner, at least one of the two regions defined by the scribe line S in the glass sheet G may be pressed by a member other than the brush-like member. However, even in this case, it is preferable to press the two regions defined by the scribe line S in the glass sheet G by substantially equal forces.

Further, the present invention is not limited to the above description, in which each brush 20a and 20b has a rectangular shape along the scribe line S as viewed in the normal direction of the second main surface Gb, and the brush 20a extending in the longitudinal direction presses one of the two regions defined by the scribe line S in the glass sheet G while the brush 20b extending in the longitudinal direction presses the other region. At least one of the two regions defined by the scribe line S in the glass sheet G may be pressed by a brush-like pressing member separated in plural.

Furthermore, the present invention is not limited to the above description, in which the glass sheet cutting apparatus 100 cuts the glass sheet G along the scribe line S located at the substantial center of the glass sheet G. The glass sheet cutting apparatus 100 may cut the glass sheet G along a scribe line S located at an end part of the glass sheet G.

Still more, the present invention is not limited to the above description, in which the pressing member 20 set above the glass sheet G is brought down toward the glass sheet G in the vertical direction, and then, the cleaving member 10 set below the glass sheet G is brought up toward the glass sheet G in the vertical direction. It is possible that after the pressing member 20 set below the glass sheet G is brought up toward the glass sheet G in the vertical direction, the cleaving member 10 set above the glass sheet G is brought down toward the glass sheet G in the vertical direction. In this case, the scribe line S is formed in the lower surface of the glass sheet G, which can facilitate removal of glass powder made in association with formation of the scribe line S.

Moreover, the present invention is not limited to the above description, in which the cleaving member 10 and the pressing member 20 are moved toward the glass sheet G in the vertical directions. It is possible that after the pressing member 20 is moved horizontally toward the second main surface Gb of the glass sheet G being held so that the main surfaces Ga and Gb are parallel to the vertical direction, the cleaving member 10 is moved horizontally toward the first main surface Ga of the glass sheet G. However, where the glass sheet G is comparatively large, conveyance of the horizontally held glass sheet G is easier than conveyance of the vertically held glass sheet G. For this reason, it is preferable to move the cleaving member 10 and the pressing member 20 toward the glass sheet G in the vertical direction in cutting the glass sheet G.

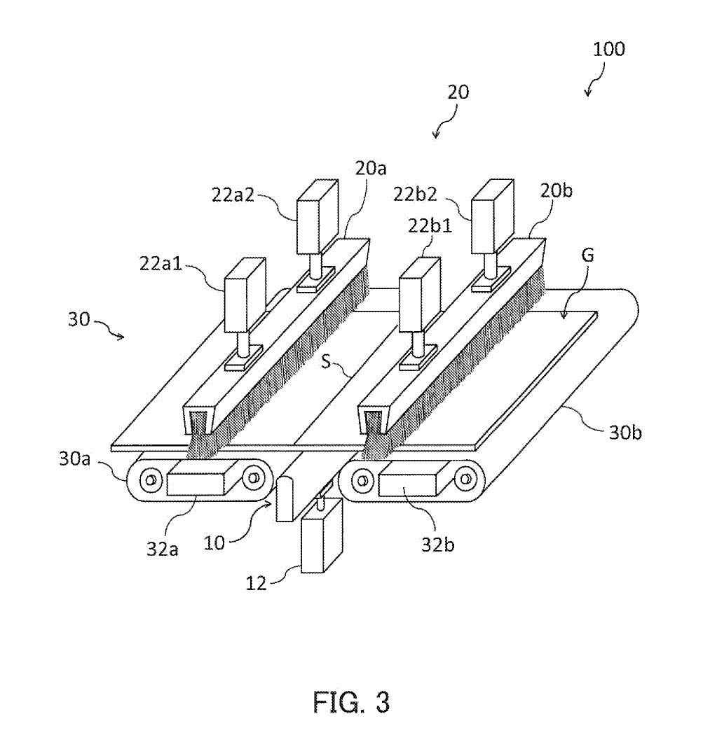

More specific examples of the glass sheet cutting apparatus 100 according to the present embodiment will be described below with reference to FIGS. 3-6. FIG. 3 is a schematic illustration of a glass sheet cutting apparatus 100 according to the present embodiment. The glass sheet cutting apparatus 100 shown in FIG. 3 includes a glass sheet conveyor device 30 in addition to a cleaving member 10 and a pressing member 20.

The glass sheet conveyor device 30 includes belt conveyors 30a and 30b at a predetermined distance, e.g., 100 mm spaced apart from each other. Here, the belt conveyor 30a rotates in a circumferential manner around a surface plate 32a, while the belt conveyor 30b rotates in a circumferential manner around a surface plate 32b. Preferably, the surface plates 32a and 32b are configured so as to be capable of vacuum sucking the glass sheet G. The belt conveyors 30a and 30b convey the glass sheet G in which a scribe line S is formed.

Here, the glass sheet G is conveyed from one of the belt conveyors 30a and 30b to the other in a direction substantially orthogonal to the longitudinal direction of the scribe line S. After the conveyed glass sheet G is stopped, the glass sheet G is cut. The cleaving member 10 is arranged between the belt conveyors 30a and 30b located below the glass sheet G. The cleaving member 10 is in a pole (bar) shape and is arranged substantially in parallel to the scribe line S in the glass sheet G. A lifting apparatus 12 moves the cleaving member 10 so as to change the distance from the cleaving member 10 to the glass sheet G.

The pressing member 20 is arranged above the glass sheet conveyor device 30. The pressing member 20 includes linear channel brushes 20a and 20b. For example, resin fibers of the brushes 20a and 20b have a diameter of about 0.07 mm and a length of about 10.0 mm. The implant pitch (intervals of adjacent bristles) of the resin fibers is about 8.0 mm. The length in the longitudinal direction of the brushes 20a and 20b is about 3000 mm.

The channel brushes 20a and 20b are arranged above the belt conveyors 30a and 30b, respectively, at a predetermined distance spaced therebetween. The channel brushes 20a and 20b are arranged substantially in parallel to the scribe line S in the glass sheet G. The channel brush 20a moves in the vertical direction by lifting apparatuses 22a1 and 22a2. The channel brush 20b moves in the vertical direction by lifting apparatuses 22b1 and 22b2. It is noted that the surface plate 32a is preferably arranged at a location corresponding to the channel brush 20a. Preferably, the glass sheet G is interposed between the channel brush 20a and the surface plate 32a when the channel brush 20a is brought down. Similarly, it is preferable to arrange the surface plate 32b at a location corresponding to the channel brush 20b. Preferably, the glass sheet G is interposed between the channel brush 20b and the surface plate 32b when the channel brush 20b is brought down.

Cutting of the glass sheet G is performed as follows. First, the glass sheet conveyor device 30 conveys the glass sheet G in which the scribe line S is formed. In one example, after the scribe line S is formed in the glass sheet G by a scribe line forming apparatus (not shown herein), the glass sheet conveyor device 30 conveys the glass sheet G to a site where the cleaving member 10 and the pressing member 20 are arranged. The glass sheet G is conveyed by pitch feed. When it is detected that the scribe line S reaches between the belt conveyors 30a and 30b, the glass sheet G is stopped.

Next, the lifting apparatuses 22a1, 22a2, 22b1, and 22b2 bring down the channel brushes 20a and 20b of the pressing member 20, thereby pressing the glass sheet G. Thereafter, the lifting apparatus 12 brings up the cleaving member 10 to apply the force to the glass sheet G, thereby cutting the glass sheet G. It is noted that in order to cut the glass sheet G into two equal parts along the scribe line S, it is preferable that the channel brushes 20a and 20b press the glass sheet G at substantially equal distances apart from the scribe line S.

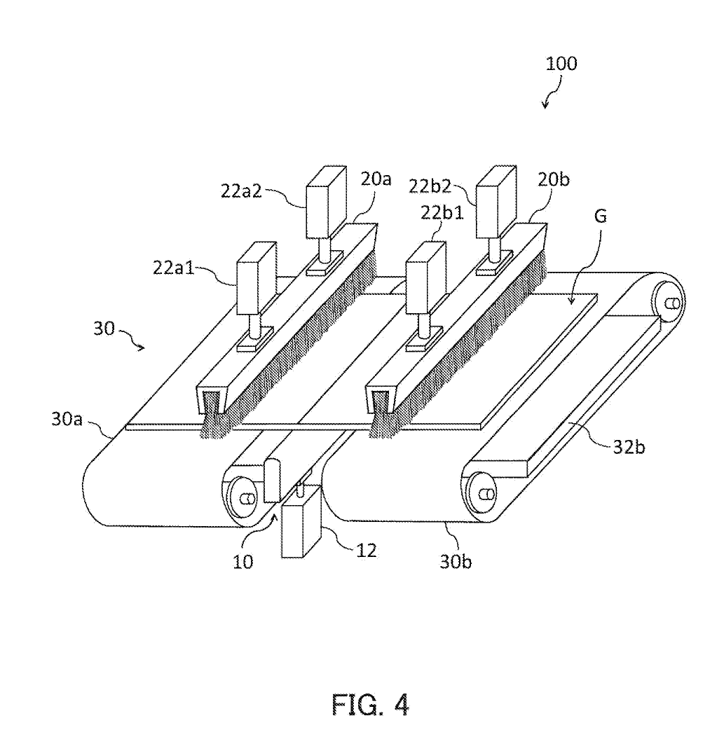

FIG. 4 is a schematic illustration of another glass sheet cutting apparatus 100 according to the present embodiment. The glass sheet cutting apparatus 100 shown in FIG. 4 has a configuration similar to that of the glass sheet cutting apparatus 100 described with reference to FIG. 3, except the conveyance direction of the glass sheet G and a configuration relating thereto. Therefore, duplicate description is omitted in order to avoid redundancy. Here, belt conveyors 30a and 30b convey a glass sheet G in parallel to the longitudinal direction of the scribe line S before or after the glass sheet G is cut.

It is noted that the present invention is not limited to the above description with reference to FIGS. 3 and 4, in which each glass sheet cutting apparatus 100 cuts the glass sheet G along the scribe line S located at the substantial center of the glass sheet G. The glass sheet cutting apparatus 100 may cut the glass sheet G along a scribe line S located in an end region of the glass sheet G.

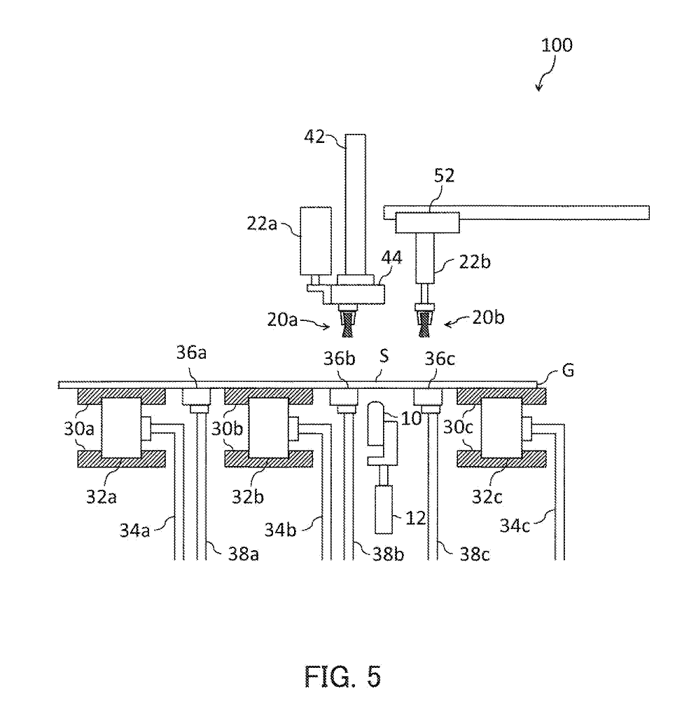

FIG. 5 is a schematic illustration of another glass sheet cutting apparatus 100 according to the present embodiment. In the glass sheet cutting apparatus 100 shown in FIG. 5, a channel brush 20a is mounted on a suction nozzle 44 connected to a suction duct 42. Glass powder, which may be generated at pressing by the channel brush 20a and cutting of the glass sheet G, is removed through the suction nozzle 44 and the suction duct 42. A lifting apparatus 22a moves the channel brush 20a and the suction nozzle 44 in the vertical direction.

Also, the channel brush 20b is mounted on a lifting apparatus 22b. The lifting apparatus 22b is capable of being moved in the horizontal direction by a running gear 52. Accordingly, the channel brush 20b is capable of being moved in the vertical direction and the horizontal direction by the lifting apparatus 22b and the running gear 52.

Belt conveyors 30a and 30b, suction surface plates 32a and 32b, and air floating plates 36a and 36b are arranged at locations on one of the two regions defined by the scribe line S in the glass sheet G. While, a belt conveyor 30c, a suction surface plate 32c, and an air floating plate 36c are arranged at locations on the other region. The belt conveyor 30a rotates in a circumferential manner around the suction surface plate 32a. The suction surface plate 32a is connected to a suction duct 34a. In one example, formation of ventilation holes in the belt conveyors 30a and 30b can suck and fix the glass sheet G by the suction surface plate 32a in cutting the glass sheet G. The air floating plate 36a is connected to an air duct 38a and ejects air to the glass sheet G. In one example, the air floating plate 36a ejects air to the glass sheet G in conveyance of the glass sheet G. The air floating plate 36a is arranged in the vicinity of the belt conveyor 30a. Similarly, the belt conveyor 30b rotates in a circumferential manner around the suction surface plate 32b. The suction surface plate 32b is connected to a suction duct 34b. The air floating plate 36b is connected to an air duct 38b and ejects air to the glass sheet G. The air floating plate 36b is arranged in the vicinity of the belt conveyor 30b. Further, the belt conveyor 30c rotates in a circumferential manner around the suction surface plate 32c. The suction surface plate 32c is connected to a suction duct 34c. The air floating plate 36c is connected to an air duct 38c and ejects air to the glass sheet G. The air floating plate 36c is arranged in the vicinity of the belt conveyor 30c. With the glass sheet cutting apparatus 100 like this, an end part of the glass sheet G can be cut favorably. It is noted that in this case, the channel brushes 20a and 20b may press the glass sheet G at different distances spaced apart from the scribe line S as necessary.

Yet further, in the glass sheet cutting apparatus 100 shown in FIG. 5, it is preferable that the air floating plate 36b is arranged at a location corresponding to the channel brush 20a, and the glass sheet G is interposed between the channel brush 20a and the air floating plate 36b when the channel brush 20a is brought down. Similarly, it is preferable that the air floating plate 36c is arranged at a location corresponding to channel brush 20b, and the glass sheet G is interposed between the channel brush 20b and the air floating plate 36c when the channel brush 20b is brought down.

It is noted that the present invention is not limited to the above description, in which the glass sheet G is cut one time. The glass sheet G may be cut plural times.

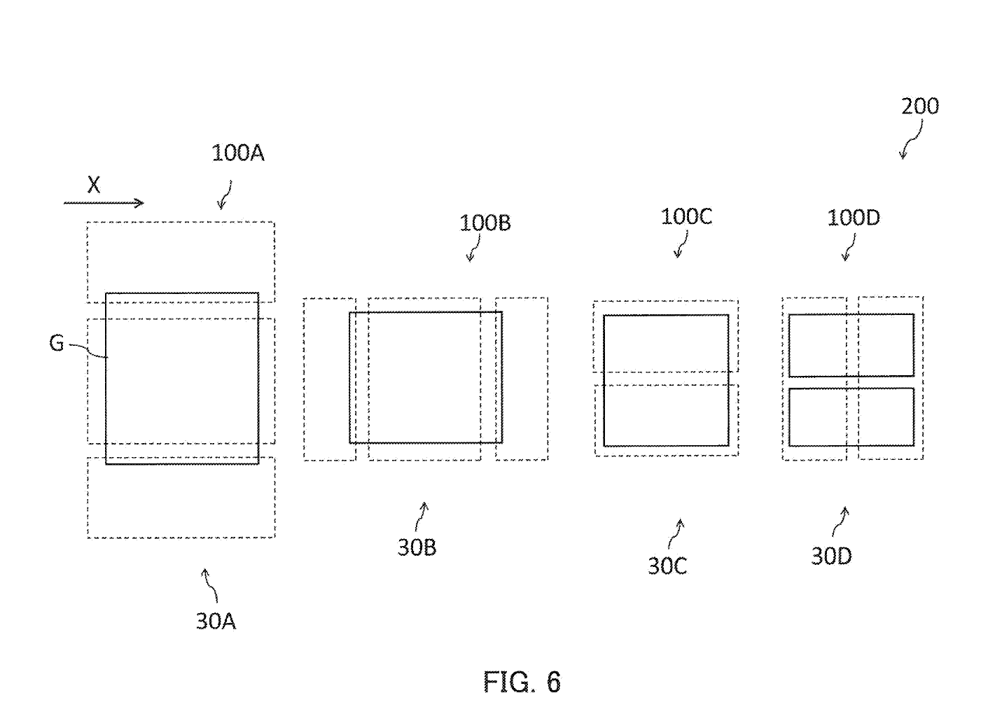

With reference to FIG. 6, a glass sheet cutting system 200 according to the present embodiment will be described below. The glass sheet cutting system 200 includes a plurality of glass sheet cutting apparatuses 100 described above. Here, the glass sheet cutting system 200 includes four glass sheet cutting apparatuses 100, which will be denoted by 100A to 100D in the order of cutting a glass sheet G. It is noted that FIG. 6 shows the glass sheet G conveyed in a conveyance direction X, wherein the solid lines indicate the glass sheet G to be cut by the glass sheet cutting apparatuses 100A-100D, while the dotted lines indicate glass sheet conveyor devices 30A-30D that convey the glass sheet G. Further, in order to avoid an excessively complicated drawing, the conveyor devices between the glass sheet cutting apparatuses 100A-100D are omitted herein.

Here, four glass sheets are manufactured from the glass sheet G set in the glass sheet cutting system 200. First, the glass sheet cutting apparatus 100A cuts each opposite end part of the glass sheet G substantially in parallel to the conveyance direction. The cut opposite end parts may be scrapped or reused by any optional means. The glass sheet conveyor device 30A conveys the glass sheet G substantially in parallel to the direction in which the glass sheet cutting apparatus 100A cuts the glass sheet G.

Next, the glass sheet cutting apparatus 100B cuts each opposite end part of the glass sheet G substantially vertically to the conveyance direction. The cut opposite end parts may be scrapped or reused by any optional means. The glass sheet conveyor device 30B conveys the glass sheet G substantially vertically to the direction in which the glass sheet cutting apparatus 100B cuts the glass sheet G.

Subsequently, the glass sheet cutting apparatus 100C cuts the glass sheet G substantially in parallel to the conveyance direction. The glass sheet cutting apparatus 100C cuts the conveyed glass sheet G into substantially equal two parts. The glass sheet conveyor device 30C conveys the glass sheet G substantially in parallel to the direction in which the glass sheet cutting apparatus 100C cuts the glass sheet G.

Next, the glass sheet cutting apparatus 100D cuts the glass sheet G substantially vertically to the conveyance direction. The glass sheet cutting apparatus 100D cuts the conveyed glass sheet G into substantially equal two parts. The glass sheet conveyor device 30D conveys the glass sheet G substantially vertically to the direction in which the glass sheet cutting apparatus 100A cuts the glass sheet G. Thus, the glass sheet cutting apparatuses 100A-100D can manufacture glass sheets G.

It is noted that even in the case where a defect is made in some part of a comparatively large glass sheet, manufacture of glass sheets by cutting the glass sheet can achieve utilization of comparatively small glass sheets free of defects. In recent years, a demand for large-sized screens for flat panel displays (e.g., liquid crystal panel displays) yields a demand for large-sized glass sheets over a size of 2 m wide and 2 m long, for example. However, where a several-micrometer defect is present in such a large glass sheet, the glass sheet cannot be used as a large-sized glass sheet. However, when comparatively small plural glass sheets are manufactured by cutting a large glass sheet with a minute defect for use as small-sized glass sheets with no defect, effective utilization of the glass sheet can be achieved.

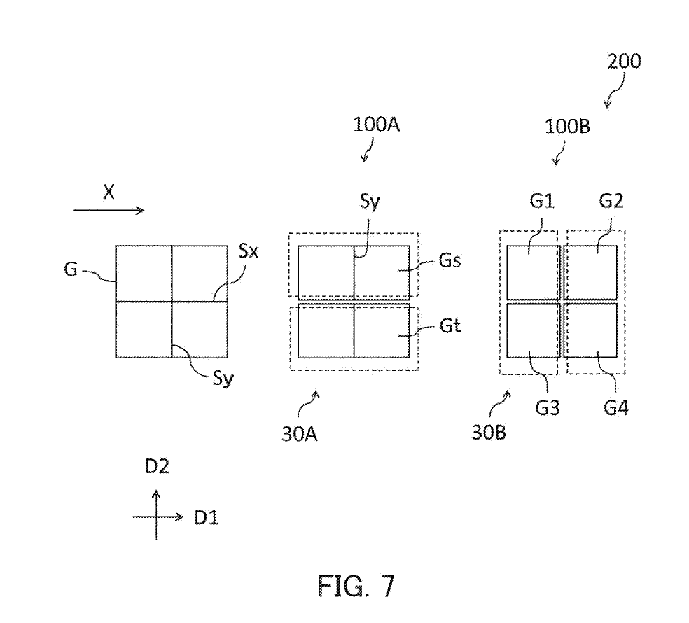

Referring to FIG. 7, a glass sheet cutting system 200 according to the present embodiment will be described herein. The glass sheet cutting system 200 includes a glass sheet cutting apparatus 100A and a glass sheet cutting apparatus 100B. In the glass sheet cutting system 200 of the present embodiment, the glass sheet cutting apparatuses 100A and 100B cut a glass sheet G in this order. In the present specification, the glass sheet cutting apparatus 100A may be referred to as a first glass sheet cutting apparatus, while the glass sheet cutting apparatus 100B may be referred to as a second glass sheet cutting apparatus.

Each of the first glass cutting apparatus 100A and the second glass sheet cutting apparatus 100B includes a cleaving member 10 and a pressing member 20 described with reference to FIGS. 1-5. Cutting of the glass sheet G is performed as described above. However, in order to avoid an excessively complicated drawing, in FIG. 7, the cleaving member 10 and the pressing member 20 are omitted, and a glass sheet conveyor device 30A of the glass sheet cutting apparatus 100A and the glass sheet conveyor device 30B of the glass sheet cutting apparatus 100B are simplified. In one example, the glass sheet conveyor device 30A has a configuration similar to that of the glass sheet conveyor device 30 of the glass sheet cutting apparatus 100 shown in FIG. 4, while the glass sheet conveyor device 30B has a configuration similar to that of the glass sheet conveyor device 30 of the glass sheet cutting apparatus 100 shown in FIG. 3. It is noted that the glass sheet cut by the glass sheet cutting apparatuses 100A and 100B and the scribe lines are indicated by the solid line, while the glass sheet conveyor devices 30A and 30B that convey the glass sheet are indicated by the dotted line in FIG. 7.

The glass sheet G is conveyed from the upstream side to the downstream side in a conveyance direction X. Typically, the glass sheet G is conveyed from the upstream side to the downstream side in the conveyance direction X as it is without rotation and change in the normal direction of its main surfaces.

First, the glass sheet G, in which scribe lines Sx and Sy extending in directions D1 and D2 intersecting with each other are formed, is conveyed to the glass sheet cutting apparatus 100A. The scribe lines Sx and Sy in the glass sheet G may be formed in the course of conveyance to the glass sheet cutting apparatus 100A in the conveyance direction X. Alternatively, the glass sheet G in which the scribe lines Sx and Sy are formed in advance may be conveyed to the glass sheet cutting apparatus 100A. It is noted that in the present embodiment, the scribe line Sx in the glass sheet G is formed in a direction D1 parallel to the conveyance direction X, while the scribe line Sy is formed in a direction D2 orthogonal to the conveyance direction X.

When the glass sheet G is conveyed to the glass sheet cutting apparatus 100A in the conveyance direction X, the glass sheet cutting apparatus 100A cuts the glass sheet G along the scribe line Sx extending in the direction D1. Here, the direction D1 is parallel to the conveyance direction X. Accordingly, the glass sheet cutting apparatus 100A cuts the glass sheet G in the direction D1 parallel to the conveyance direction X. Cutting by the glass sheet cutting apparatus 100A results in manufacture of glass sheets Gs and Gt from the glass sheet G.

Thereafter, when the glass sheets Gs and Gt are conveyed to the glass sheet cutting apparatus 100B in the conveyance direction X, the glass sheet cutting apparatus 100B cuts the glass sheets Gs and Gt along the scribe line Sy extending in the direction D2. Here, the direction D2 is orthogonal to the conveyance direction X. Accordingly, the glass sheet cutting apparatus 100B cuts at one time the glass sheets Gs and Gt in the direction D2 orthogonal to the conveyance direction X. Cutting by the glass sheet cutting apparatus 100B results in manufacture of glass sheets G1 and G2 from the glass sheet Gs and glass sheets G3 and G4 from the glass sheet Gt. Thus, the glass sheet cutting system 200 can manufacture the glass sheets G1-G4 from the glass sheet G.

It is noted that the present invention is not limited to the above description, in which the glass sheet cutting system 200 cuts the glass sheet G in the direction D1 parallel to the conveyance direction X of the glass sheet G first and then cuts the glass sheet G in the direction D2 orthogonal to the conveyance direction X of glass sheet G. The glass sheet cutting system 200 may cut the glass sheet G in the direction D2 orthogonal to the conveyance direction X of the glass sheet G first and then cut the glass sheet G in the direction D1 parallel to the conveyance direction X of glass sheet G.

Furthermore, the present invention is not limited to the above description, in which the brush-like member is used as the pressing member 20 of the glass sheet cutting apparatus 100 in the glass sheet cutting system 200. A rubber member may be used as the pressing member.

It is noted that end facets of the glass sheet G before being cut in the glass sheet cutting system 200 may be comparatively rough. In this case, it is preferable that the end facet part is at least scrapped once after the glass sheet cutting system 200 cuts the glass sheet G, and is reused as necessary.

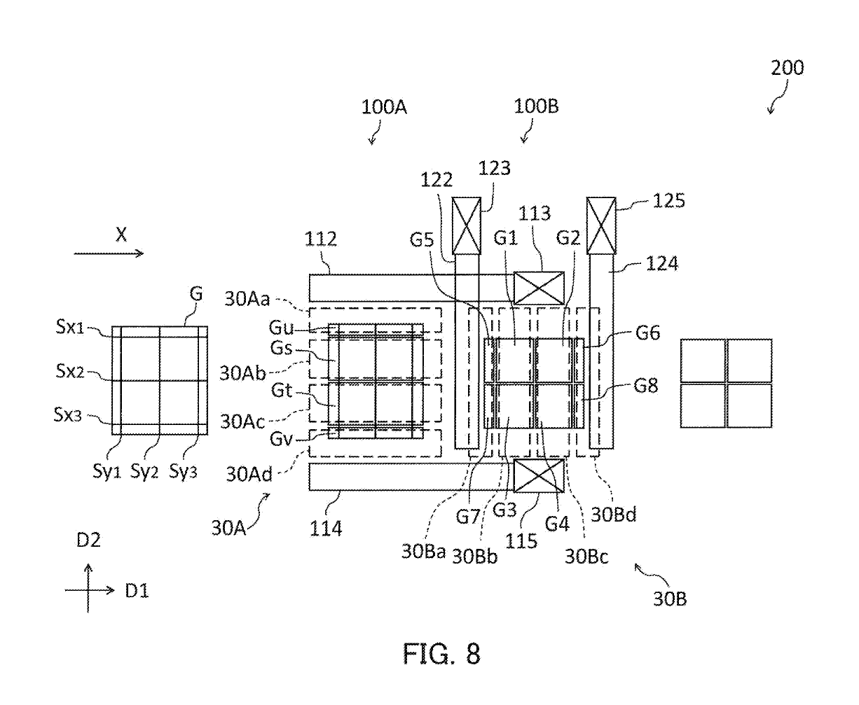

With reference to FIGS. 8-10, a glass sheet cutting system 200 according to the present embodiment will be described herein. FIG. 8 is a schematic illustration of a glass sheet cutting system 200 according to the present embodiment. The glass sheet cutting system 200 includes scrap conveyors 112, 114, 122, and 124 and scrap ports 113, 115, 123, and 125 in addition to a glass sheet cutting apparatus 100A and a glass sheet cutting apparatus 100B. The glass sheet cutting apparatuses 100A and 100B cut respective selvage parts of the glass sheet G. The selvage parts of the glass sheet G are scrapped.

Each of the glass sheet cutting apparatuses 100A and 100B includes a cleaving member and a pressing member and cuts the glass sheet G as described above. However, in order to avoid an excessively complicated drawing, the cleaving member and the pressing member are omitted in the FIG. 8, likewise in FIG. 7. It is noted that each of the glass sheet cutting apparatuses 100A and 100B in the glass sheet cutting system 200 of the present embodiment includes three cleaving members and six pressing members, different from the glass sheet cutting system 200 described with reference to FIG. 7. Two pressing members are arranged to be opposite to each cleaving member. Accordingly, the glass sheet cutting apparatus 100A can cut the glass sheet along three scribe lines at one time. Also, the glass sheet cutting apparatus 100B can cut the glass sheet along three scribe lines at one time. It is noted that brush-like members or rubber members may be used as the pressing members, as described above.

The glass sheet conveyor device 30A includes belt conveyors 30Aa, 30Ab, 30Ac, and 30Ad. The belt conveyors 30Aa, 30Ab, 30Ac, and 30Ad each are capable of conveying the glass sheet in the conveyance direction X and are arranged slightly apart from each other in the direction D2. The cleaving members are arranged between the belt conveyors 30Aa, 30Ab, 30Ac, and 30Ad correspondingly. In one example, the belt conveyors 30Aa-30Ad of the glass sheet conveyor device 30A each have a configuration similar to that of the belt conveyors 30a and 30b of the glass sheet conveyor device 30 of the glass sheet cutting apparatus 100 shown in FIG. 4.

As well, the glass sheet conveyor device 30B includes belt conveyors 30Ba, 30Bb, 30Bc, and 30Bd. The belt conveyors 30Ba, 30Bb, 30Bc, and 30Bd each are capable of conveying the glass sheet in the conveyance direction X and are arranged slightly apart from each other in the direction D1. The cleaving members are arranged between the belt conveyors 30Ba, 30Bb, 30Bc, and 30Bd correspondingly. In one example, the belt conveyors 30Ba-30Bd of the glass sheet conveyor device 30B each have a configuration similar to that of the belt conveyors 30a and 30b of the glass sheet conveyor device 30 of the glass sheet cutting apparatus 100 shown in FIG. 3.

It is noted that by moving the belt conveyors 30Aa-30Ad in, for example, the direction D2 so as to change their intervals, cutting positions can be appropriately changed even if the positions of the scribe lines varies depending on glass sheets. Similarly, by moving the belt conveyors 30Ba-30Bd in the direction D1 so as to change their intervals, cutting positions can be appropriately changed even if the positions of the scribe lines vary depending on glass sheets.

The scrap conveyors 112 and 114 are arranged outside the glass sheet conveyor device 30A and each include a conveyance path parallel to the direction D1. Further, the scrap conveyors 122 and 124 are arranged outside the glass sheet conveyor device 30B and each include a conveyance path parallel to the direction D2. The scrap ports 113, 115, 123, 125 are formed at the terminal ends of the conveyance paths of the scrap conveyors 112, 114, 122, and 124, respectively.

The glass sheet cutting system 200 of the present embodiment cuts a glass sheet G as follows. Note first that in the glass sheet G conveyed by the glass sheet cutting apparatus 100A, a plurality of scribe lines Sx1, Sx2, and Sx3 extending in the direction D1 are formed, while a plurality of scribe lines Sy1, Sy2, and Sy3 extending in the direction D2 are formed. When viewing a cross section of the glass sheet G in parallel to the direction D2, the scribe lines Sx1 and Sx3 are located in the vicinity of its edges, and the scribe line Sx2 is located at its center. Further, when viewing a cross section thereof in parallel to the direction D1, the scribe lines Sy1 and Sy3 are located in the vicinity of its edges, and the scribe line Sy2 is located at its center.

When the glass sheet G is conveyed to the glass sheet cutting apparatus 100A, the glass sheet cutting apparatus 100A cuts the glass sheet G at one time along the scribe lines Sx1, Sx2, and Sx3 extending in the direction D1. Cutting by the glass sheet cutting apparatus 100A results in manufacture of glass sheets Gs, Gt, Gu, and Gv from the glass sheet G.

After cutting the glass sheet G, the glass sheet cutting apparatus 100A moves the glass sheet Gu, which is located on one end side, out of the glass sheets Gs and Gu cut along the scribe line Sx1, which is located on the end side, out of the scribe lines Sx1-Sx3 from the belt conveyor 30Aa to the scrap conveyor 112. Thereafter, the scrap conveyor 112 conveys the glass sheet Gu to the scrap port 113. Further, after cutting the glass sheet G, the glass sheet cutting apparatus 100A moves the glass sheet Gv, which is located on one end side, out of the glass sheets Gt and Gv cut along the scribe line Sx3, which is located on the other end side, out of the scribe lines Sx1-Sx3 from the belt conveyor 30Ad to the scrap conveyor 114. Thereafter, the scrap conveyor 114 conveys the glass sheet Gv to the scrap port 115.

When the glass sheets Gs and Gt are conveyed to the glass sheet cutting apparatus 100B, the glass sheet cutting apparatus 100B cuts the glass sheets Gs and Gt at one time along the scribe lines Sy1, Sy2, and Sy3 extending in the direction D2. Cutting by the glass sheet cutting apparatus 100B results in manufacture of glass sheets G1, G2, G5, and G6 from the glass sheet Gs and glass sheets G3, G4, G7, and G8 from the glass sheet Gt.

After cutting the glass sheets Gs and Gt, the glass sheet cutting apparatus 100B moves the glass sheets G5 and G7, which are located on one end side, out of the glass sheets G1, G5, G3, and G7 cut along the scribe line Sy1, which is located on the end side, out of the scribe lines Sy1-Sy3 from the belt conveyor 30Ba to the scrap conveyor 122. Thereafter, the scrap conveyor 122 conveys the glass sheets G5 and G7 to the scrap port 123. Further, after cutting the glass sheets Gs and Gt, the glass sheet cutting apparatus 100B moves the glass sheets G6 and G8, which are located on one end side, out of the glass sheets G2, G6, G4, and G8 cut along the scribe line Sy3, which is located on the other end side, out of the scribe lines Sy1-Sy3 from the belt conveyor 30Bd to the scrap conveyor 124. Thereafter, the scrap conveyor 124 conveys the glass sheets G6 and G8 to the scrap port 125. In this way, the glass sheet cutting system 200 manufactures the glass sheets G1-G4, while scrapping the selvage parts of the glass sheet G.

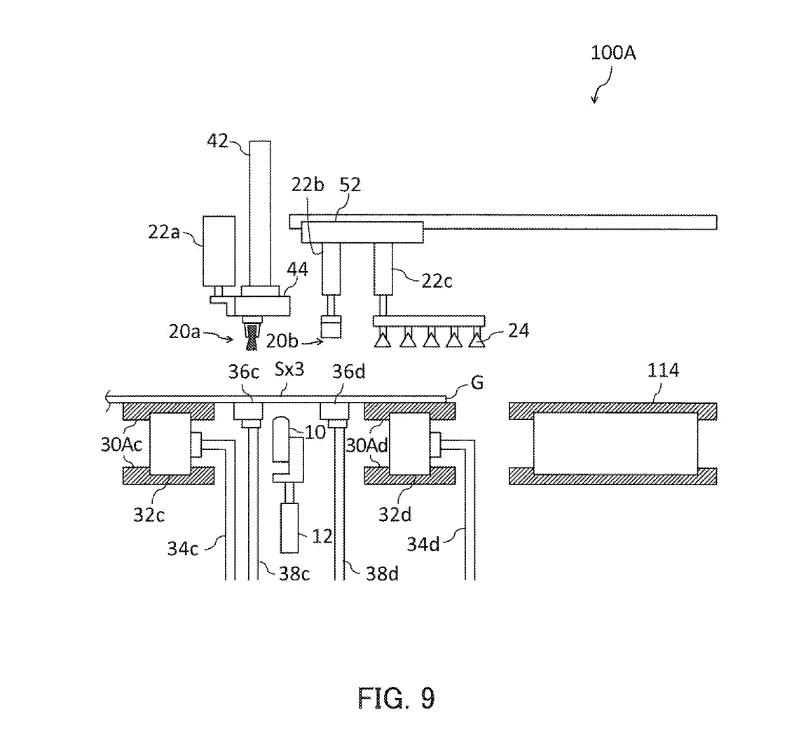

With reference to FIGS. 8 and 9, detailed description will be made herein about the configuration in the vicinity of the belt conveyors 30Ac and 30Ad of the glass sheet cutting apparatus 100A in the glass sheet cutting system 200 shown in FIG. 8. FIG. 9 is a schematic illustration showing the vicinity of the belt conveyors 30Ac and 30Ad of the glass sheet cutting apparatus 100A. In the glass sheet cutting apparatus 100A shown in FIG. 9, a channel brush 20a is mounted on a suction nozzle 44 connected to a suction duct 42. Glass powder, which may be generated at pressing by the channel brush 20a and cutting of the glass sheet G, is removed through the suction nozzle 44 and the suction duct 42. A lifting apparatus 22a moves the channel brush 20a and the suction nozzle 44 in the vertical direction. The channel brush 20a is used as the pressing member.

A linearly extending rubber 20b is mounted on a lifting apparatus 22b. The lifting apparatus 22b is capable of being moved in the horizontal direction by a running gear 52. The rubber 20b is used as the pressing member.

Further, a suction pad 24 is mounted on a lifting apparatus 22c. The lifting apparatus 22c is capable of being moved in the horizontal direction by the running gear 52. Accordingly, the rubber 20b and the suction pad 24 are capable of being moved in the vertical direction and the horizontal direction by the lifting apparatuses 22b and 22c and the running gear 52.

A belt conveyor 30Ac, a suction surface plate 32c, and an air floating plate 36c are arranged on one of the two regions defined by the scribe line Sx3 in the glass sheet G. While on the other hand, a belt conveyor 30Ad, a suction surface plate 32d, and an air floating plate 36d are arranged on the other region. The belt conveyor 30Ac rotates in a circumferential manner around the suction surface plate 32c. The suction surface plate 32c is connected to a suction duct 34c. In one example, formation of ventilation holes in the belt conveyors 30Ac and 30Ad can suck and fix the glass sheet G to the suction surface plate 32c in cutting the glass sheet G. The air floating plate 36c is connected to an air duct 38c and ejects air to the glass sheet G. In one example, the air floating plate 36c ejects air to the glass sheet G in conveyance of the glass sheet G. The air floating plate 36c is arranged in the vicinity of the belt conveyor 30Ac. Similarly, the belt conveyor 30Ad rotates in a circumferential manner around the suction surface plate 32d. The suction surface plate 32d is connected to a suction duct 34d. The air floating plate 36d is connected to an air duct 38d and ejects air to the glass sheet G. The air floating plate 36d is arranged in the vicinity of the belt conveyor 30Ad.

The scrap conveyor 114 includes a conveyance path parallel to the belt conveyor 30Ad. The top surface of the scrap conveyor 114 is almost equal in height to the top surfaces of the belt conveyors 30Ac and 30Ad.

After the glass sheet cutting apparatus 100A cuts the glass sheet G to manufacture the glass sheets Gs, Gt, Gu, and Gv (see FIG. 8), the lifting apparatus 22c slightly brings up the glass sheet Gv sucked to the suction pad 24 with the glass sheet Gv sucked by the suction pad 24. Subsequently, the running gear 52 moves horizontally to above the scrap conveyor 114 with the glass sheet Gv sucked by the suction pad 24. Then, the glass sheet Gv is placed onto the scrap conveyor 114. Thereafter, the scrap conveyor 114 conveys the glass sheet Gv to the scrap port 115 (see FIG. 8).

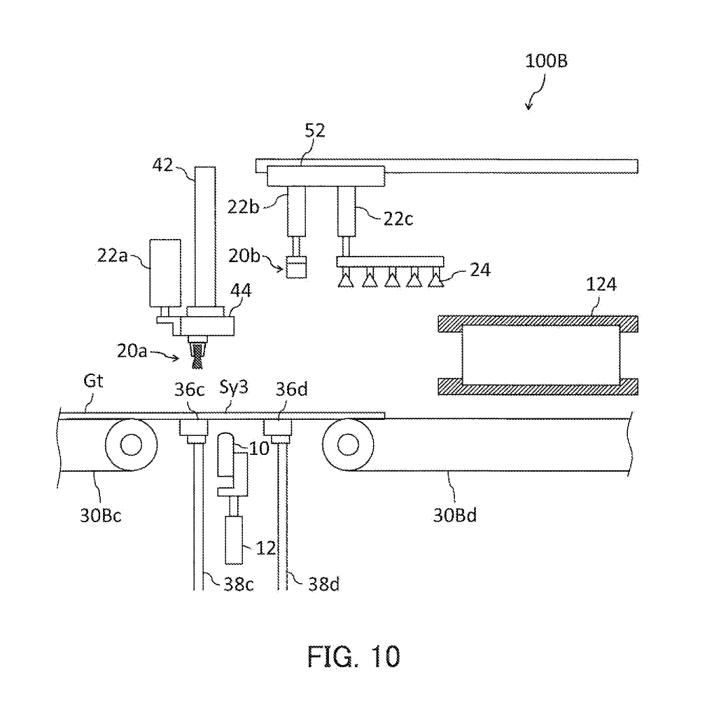

With reference to FIGS. 8 and 10, detailed description will be made next about the configuration in the vicinity of the belt conveyors 30Bc and 30Bd of the glass sheet cutting apparatus 100B in the glass sheet cutting system 200 shown in FIG. 8. FIG. 10 is a schematic illustration of the vicinity of the belt conveyors 30Bc and 30Bd of the glass sheet cutting apparatus 100B. In the glass sheet cutting apparatus 100B shown in FIG. 10, a channel brush 20a is mounted on a suction nozzle 44 connected to a suction duct 42. Glass powder, which may be generated at pressing by the channel brush 20a and cutting of the glass sheet Gt, is removed through the suction nozzle 44 and the suction duct 42. A lifting apparatus 22a moves the channel brush 20a and the suction nozzle 44 in the vertical direction. The channel brush 20a is used as the pressing member.

A linearly extending rubber 20b is mounted on a lifting apparatus 22b. The lifting apparatus 22b is capable of being moved in the horizontal direction by a running gear 52. The rubber 20b is used as the pressing member.

Further, a suction pad 24 is mounted on a lifting apparatus 22c. The lifting apparatus 22c is capable of being moved in the horizontal direction by the running gear 52. Accordingly, the rubber 20b and the suction pad 24 are capable of being moved in the vertical direction and the horizontal direction by the lifting apparatuses 22b and 22c and the running gear 52.

A belt conveyor 30Bc, a suction surface plate (not shown), and an air floating plate 36c are arranged on one of the two regions defined by the scribe line Sy3 in the glass sheet Gt. While on the other hand, a belt conveyor 30Bd, a suction surface plate (not shown), and an air floating plate 36d are arranged on the other region. In cutting the glass sheet Gt, the glass sheet Gt is sucked by and fixed to the suction surface plates. The air floating plate 36c is connected to an air duct 38c and ejects air to the glass sheet Gt. In one example, the air floating plate 36c ejects air to the glass sheet Gt in conveyance of the glass sheet Gt. The air floating plate 36c is arranged in the vicinity of the belt conveyor 30Bc. Similarly, the air floating plate 36d is connected to an air duct 38d and ejects air to the glass sheet Gt. The air floating plate 36d is arranged in the vicinity of the belt conveyor 30Bd.

A scrap conveyor 124 includes a conveyance path orthogonal to the belt conveyor 30Bd. The scrap conveyor 124 is arranged at a level higher than the belt conveyors 30Bc and 30Bd.

The glass sheet cutting apparatus 100B cuts the glass sheets Gs and Gt to manufacture the glass sheets G2, G4, G6, and G8 (see FIG. 8). Then, with the glass sheets G6 and G8 sucked by the suction pad 24, the lifting apparatus 22c brings up the glass sheets G6 and G8 sucked to the suction pad 24 up to a comparatively high level. Subsequently, the running gear 52 moves horizontally to above the scrap conveyor 124 with the glass sheets G6 and G8 sucked to the suction pad 24. Then, the glass sheets G6 and G8 are placed onto the scrap conveyor 124. Thereafter, the scrap conveyor 124 conveys the glass sheets G6 and G8 to the scrap port 125 (see FIG. 8).

As described above and shown in FIGS. 9 and 10, either the channel brush 20a or the rubber 20b may be used as the pressing member of the glass sheet cutting apparatuses 100A and 100B of the glass sheet cutting system 200. However, the use of the rubber 20b as the pressing member 20 may make a flaw on the glass sheet, as described above. Therefore, the rubber 20b is preferably used to press a part of the glass sheet which is to be scrapped.

It is noted that the present invention is not limited to the above description with reference to FIGS. 8-10, in which the glass sheet cutting system 200 scraps all the end parts of the glass sheet G. Only some of the end parts of the glass sheet G may be scrapped. Alternatively, the scrap conveyors 112, 114, 122, and 124 may be arranged only necessary sites according to a to-be-scrapped end part of the glass sheet G.

Further, the present invention is not limited to the above description with reference to FIGS. 8-10, in which after the glass sheet cutting apparatus 100A cuts the glass sheet along the scribe lines Sx1-Sx3, the glass sheet cutting apparatus 100B cuts the glass sheet along the scribe lines Sy1-Sy3. In one example, after the glass sheet cutting apparatus 100A may cut the glass sheet along the scribe lines Sy1-Sy3, the glass sheet cutting apparatus 100B may cut the glass sheet G along the scribe lines Sx1-Sx3.

Moreover, the present invention is not limited to the above description with reference to FIGS. 8-10, in which one of the glass sheet cutting apparatuses 100A and 100B cuts the glass sheet G along all the plural scribe lines extending in the direction D1, and the other glass sheet cutting apparatus 100B or 100A cuts the glass sheet G along all the plural scribe lines extending in the direction D2. In one example, one of the glass sheet cutting apparatuses may perform cutting along some of the plural scribe lines extending in one of the directions D1 and D2 in the glass sheet G, and then, the other glass sheet cutting apparatus may perform cutting along the other of the plural scribe lines extending in the same direction in the glass sheet G.

It is noted that in the glass sheet cutting system 200 described with reference to FIG. 8, even when the positions of the scribe lines may differ depending on glass sheets G, the belt conveyors 30Aa-30Ad and 30Ba-30Ba of the glass sheet conveyor devices 30A and 30B can move to the cutting positions. However, in the case, for example, where a glass sheet G long in the conveyance direction X is to cut along the scribe lines Sy1-Sy3, appropriate conveyance of the glass sheet may not be achieved if the intervals between the belt conveyors 30Ba-30Bd is too wide. In this case, after the intervals between the belt conveyors 30Ba-30Bd are adjusted so as not to exceed a predetermined value, the glass sheet cutting apparatus 100B cuts the glass sheet once along some of the scribe lines Sy1-Sy3. Then, the glass sheet conveyor device 30B or the like is moved to change the cutting positions of the glass sheet. Subsequently, the glass sheet cutting apparatus 100B cuts the glass sheet again along the other(s) of the scribe lines Sy1-Sy3. Thus, cutting along all the scribe lines Sy1-Sy3 can be achieved.

Yet further, in the glass sheet cutting system 200, scribe lines Sx and Sy may be formed in the glass sheet G before the glass sheet G is conveyed to the glass sheet cutting apparatus 100A that is to cut the glass sheet G.

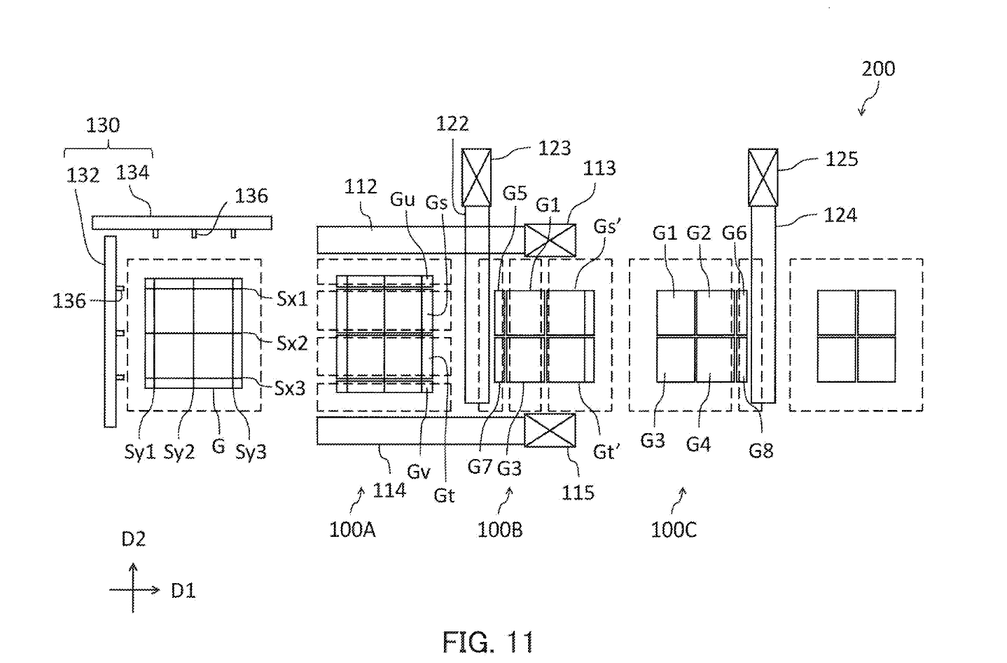

Referring to FIG. 11, a glass sheet cutting system 200 according to the present embodiment will be described below. FIG. 11 is a schematic illustration of a glass sheet cutting system 200 according to the present embodiment.

The glass sheet cutting system 200 includes glass sheet cutting apparatuses 100A, 100B, and 100C, scrap conveyors 112, 114, 122, and 124, scrap ports 113, 115, 123, and 125, and a scribe line forming apparatus 130. The scribe line forming apparatus 130 forms scribe lines Sx1-Sx3 extending in the direction D1 and scribe lines Sy1-Sy3 extending in the direction D2 before the glass sheet cutting apparatus 100A cuts the glass sheet G.

The scribe line forming apparatus 130 includes a cutter section 132 to form the scribe lines Sx1-Sx3 extending in the direction D1 and a cutter section 134 to form the scribe lines Sy1-Sy3 extending in the direction D2. Three cutters 136 are fixedly supported to the cutter section 132 with predetermined intervals left from each other. Also, three cutters 136 are fixedly supported to the cutter section 134 with predetermined intervals left from each other. The cutter section 132 moves relative to the glass sheet G to form the scribe lines Sx1-Sx3 simultaneously. Also, the cutter section 134 moves relative to the glass sheet G to form the scribe lines Sy1-Sy3 simultaneously.

Thereafter, when the glass sheet G is conveyed to the glass sheet cutting apparatus 100A in the conveyance direction X, the glass sheet cutting apparatus 100A cuts the glass sheet G along the scribe lines Sx1-Sx3. Cutting by the glass sheet cutting apparatus 100A results in manufacture of glass sheet Gs, Gt, Gu, and Gv from the glass sheet G. Next, the glass sheet cutting apparatus 100A moves to the scrap conveyor 112 the glass sheet Gu, which is located on one end side, out of the glass sheets Gs and Gu cut along the scribe line Sx1, while moving to the scrap conveyor 114 the glass sheet Gv, which is located on one end side, out of the glass sheets Gt and Gv cut along the scribe line Sx3. Thereafter, the scrap conveyor 112 conveys the glass sheet Gu to the scrap port 113, while the scrap conveyor 114 conveys the glass sheet Gv to the scrap port 115.

Next, when the glass sheets Gs and Gt are conveyed in the conveyance direction X to the glass sheet cutting apparatus 100B, the glass sheet cutting apparatus 100B cuts the glass sheets Gs and Gt along the scribe lines Sy1 and Sy2 out of the scribe lines Sy1-Sy3 extending in the direction D2, but does not cut them along the scribe line Sy3. Cutting by the glass sheet cutting apparatus 100B results in manufacture of glass sheets Gs′, G1, and G5 from the glass sheet Gs and glass sheets Gt′, G3, and G7 from the glass sheet Gt.

Subsequently, the glass sheet cutting apparatus 100B moves to the scrap conveyor 122 the glass sheets G5 and G7, which are located on one end side, out of the glass sheets G1, G3, G5, and G7 cut along the scribe line Sy1. Thereafter, the scrap conveyor 122 conveys the glass sheets G5 and G7 to the scrap port 123.

Thereafter, when the glass sheets Gs′, Gt′, G1, and G3 are conveyed to the glass sheet cutting apparatus 100C, the glass sheet cutting apparatus 100C cuts the glass sheets Gs' and Gt′ along the scribe line Sy3. Cutting by the glass sheet cutting apparatus 100C results in manufacture of glass sheets G2 and G6 from the glass sheet Gs' and glass sheets G4 and G8 from the glass sheet Gt′. Then, the glass sheet cutting apparatus 100C moves to the scrap conveyor 124 the glass sheets G6 and G8, which are located on one end side, out of the glass sheets G2, G4, G6, and G8 cut along the scribe line Sy4. The scrap conveyor 124 conveys the glass sheets G6 and G8 to the scrap port 125. Thus, cutting by the glass sheet cutting apparatuses 100A-100C can result in manufacture of the glass sheets G1-G4 from the glass sheet G.

In the glass sheet cutting system 200 according to the present embodiment, the glass sheet cutting apparatuses 100B and 100C performs cutting along the scribe lines Sy1-Sy3. Accordingly, even glass sheets G different in size can be cut efficiently. It is noted that the glass sheet cutting apparatus 100B herein cuts the glass sheet G along the scribe lines Sy1 and Sy2, which are located on the comparatively upstream side in the conveyance direction X, out of the scribe lines Sy1-Sy3. By contrast, the glass sheet cutting apparatus 100C cuts the glass sheet G along the scribe line Sy3, which is located on the most downstream side in the conveyance direction X, out of the scribe lines Sy1-Sy3.

It is also noted that the present invention is not limited to the glass sheet cutting system 200 shown in FIG. 11, in which the single glass sheet cutting apparatus cuts the glass G along the scribe lines Sx1-Sx3 in the glass sheet G, and then, the other two glass sheet cutting apparatuses cut the glass G along the scribe lines Sy1-Sy3 in the glass sheet G. The two glass sheet cutting apparatuses may cut the glass G along the scribe lines Sy1-Sy3 in the glass sheet G first, and then, the single glass sheet cutting apparatus may cut the glass G along the scribe lines Sx1-Sx3 in the glass sheet G. In addition, the glass sheet cutting system 200 manufactures the glass sheets G1-G4 from the comparatively large single glass sheet G by cutting in the above description with reference to FIGS. 6-11. However, it is apparent to skilled persons that the glass sheet cutting system 200 of the present embodiment can manufacture five or more glass sheets from the glass sheet G.

### INDUSTRIAL APPLICABILITY

According to the present invention, flaws on a glass sheet, which may be made by glass powder in cutting the glass sheet, can be reduced. Further, according to the present invention, efficient glass sheet cutting in different directions can be achieved. Thus, the glass sheet obtained by cutting mother glass can be suitably used in flat panel displays, such as liquid crystal panels, plasma display panels, etc.

### REFERENCE SINGS LIST

10 cleaving member
20 pressing member
100 glass sheet cutting apparatus

1. A glass sheet cutting apparatus comprising:
a cleaving member configured to apply a force to, of a glass sheet having a first main surface and a second main surface in which a scribe line is formed, the first main surface; and
a pressing member configured to press the second main surface of the glass sheet,
wherein the pressing member has a brush-like shape.

2. A glass sheet cutting apparatus according to claim 1, wherein
the pressing member has a rectangular shape along the scribe line as viewed in a normal direction of the second main surface.

3. A glass sheet cutting apparatus according to claim 1, wherein
the pressing member presses the glass sheet in a perpendicular direction.

4. A glass sheet cutting apparatus according to claim 1, wherein
the pressing member includes a plurality of bristles, and
each of the bristles has a diameter of 0.05 mm or larger and 0.30 mm or smaller.

5. A glass sheet cutting apparatus according to claim 4, wherein
each of the bristles has a length of 5.0 mm or longer and 20.0 mm or shorter.

6. A glass sheet cutting system, comprising:
a plurality of glass sheet cutting apparatuses each according to claim 1.

7. A glass sheet cutting system according to claim 6, wherein
scribe lines extending in a first direction or a second direction intersecting with each other are formed in the glass sheet,
the plurality of glass sheet cutting apparatuses includes:
a first glass sheet cutting apparatus configured to cut the glass sheet conveyed in a conveyance direction along the scribe line extending in the first direction; and
a second glass sheet cutting apparatus configured to cut, after the glass sheet cut by the first glass sheet cutting apparatus is conveyed in the conveyance direction, the glass sheet along the scribe line extending in the second direction.

8. A glass sheet cutting method, comprising:
pressing, of a glass sheet having a first main surface and a second main surface in which scribe line is formed, the second main surface; and
cleaving the glass sheet by applying a force to the first main surface of the glass sheet,
wherein the second main surface of the glass sheet is pressed by a brush-like pressing member in the pressing.

9. A glass sheet manufacturing method for manufacturing a glass sheet by cutting mother glass, comprising:
preparing mother glass having a first main surface and a second main surface in which a scribe line is formed;
pressing the second main surface of the mother glass; and
taking out a glass sheet manufactured by cutting the mother glass by applying a force to the first main surface of the mother glass,
wherein the second main surface of the mother glass is pressed by a brush-like pressing member in the pressing.

10. A glass sheet cutting system to cut a glass sheet in which scribe lines extending in a first direction or a second direction intersecting with each other are formed, comprising:
a first glass sheet cutting apparatus configured to cut the glass sheet conveyed in a conveyance direction along the scribe line extending in the first direction; and
a second glass sheet cutting apparatus configured to cut, after the glass sheet cut by the first glass sheet cutting apparatus is conveyed in the conveyance direction, the glass sheet along the scribe line extending in the second direction.

11. A glass sheet cutting system according to claim 10, wherein
a plurality of scribe lines extending in a direction orthogonal to the conveyance direction as the first direction or the second direction are formed in the glass sheet before being conveyed to the first glass sheet cutting apparatus, and
one of the first glass sheet cutting apparatus and the second glass sheet cutting apparatus cuts the glass sheet along some scribe line out of the plurality of scribe lines, and
the glass sheet cutting system further comprising a third glass sheet cutting apparatus configured to cut, after the glass sheet cut by the one glass sheet cutting apparatus is conveyed in the conveyance direction, the glass sheet along a scribe line, along which the one glass sheet cutting apparatus does not cut the glass sheet, out of the plurality of scribe lines.

12. A glass sheet cutting system according to claim 10, wherein
the first glass sheet cutting apparatus cuts the glass sheet in a direction parallel to the conveyance direction, and
the second glass sheet cutting apparatus cuts the glass sheet in a direction orthogonal to the conveyance direction.

13. A glass sheet cutting system according to claim 10, wherein
two or more scribe lines extending in the first direction are formed in the glass sheet before the first glass sheet cutting apparatus cuts the glass sheet, and
the first glass sheet cutting apparatus cuts the glass sheet along the plurality of scribe lines extending in the first direction at one time.

14. A glass sheet cutting system according to claim 10, further comprising:
a conveyor configured to scrap, after at least one of the first glass sheet cutting apparatus and the second glass sheet cutting apparatus cuts the glass sheet along the scribe line or the scribe lines, a glass sheet located on at least one of opposite end sides of the cut glass sheet.

15. A glass sheet cutting system according to claim 10, further comprising:
a scribe line forming apparatus configured to form, before the first glass sheet cutting apparatus cuts the glass sheet, a scribe line extending in the first direction and a scribe line extending in the second direction in the glass sheet.
